(19) United States
(12) Patent Application Publication
(10) Pub. No.: US 2018/0004185 A1
(43) Pub. Date: Jan. 4, 2018

(54) High-Precision Turning Device

(71) Applicant: CITIC Dicastal CO., LTD, Qinhuangdao (CN)

(72) Inventors: Weidong Liu, Qinhuangdao (CN); Jiandong Guo, Qinhuangdao (CN)

(73) Assignee: CITIC Dicastal CO., LTD, Qinhuangdao (CN)

(21) Appl. No.: 15/636,710

(22) Filed: Jun. 29, 2017

(30) Foreign Application Priority Data
Jun. 29, 2016 (CN) 201610492393.1

(51) Int. Cl. G05B 19/31; G01B 7/30; G01B 21/22; B24B 53/12

(52) U.S. Cl. CPC G05B 19/318; G01B 21/22; G01B 7/30; B24B 53/12

(57) ABSTRACT

A high-precision turning device. The device has a base plate, a base, a support A, wherein a groove is formed in the center of the bottom surface of the base, and a lead screw passes through the groove; symmetrical T-shaped annular grooves are formed in two sides of the interior of the base, two symmetrical T-shaped annular columns are arranged on the lower end face of a turning block, and the T-shaped annular columns can be inserted into the T-shaped annular grooves; and the structure of a central position of the lower end face of the turning block is annular teeth, and the annular teeth are meshed with the lead screw. A servomotor drives the lead screw to rotate, and by virtue of meshing matching of the annular teeth and the lead screw, the turning block can turn along the centers of the T-shaped annular grooves in the base.

### TECHNICAL FIELD

The present invention relates to a wheel machining device, and in particular to a high-precision turning device.

### BACKGROUND ART

Multiple wheel detection items exist in the automobile wheel manufacturing industry, sometimes the wheel needs to turn for a certain angle to be detected, and the turning precision of the wheel is an important factor for influencing the detection precision. Therefore, the present invention provides a high-precision turning device.

### SUMMARY OF THE INVENTION

An object of the present invention is to provide a high-precision turning device.

To achieve the object described above, a technical solution of the present invention is as follows: a high-precision turning device is composed of a base plate, a base, a support A, a lead screw, a turning block, a support B, a coupling, and a servomotor. The support A, the support B and the base are fixed on the base plate, the lead screw is mounted above the base plate through the support A and the support B, and the coupling connects the lead screw with the servomotor. An empty groove is formed in the center of the bottom surface of the base, and the lead screw passes through the empty groove; symmetrical T-shaped annular grooves are formed in two sides of the interior of the base, two symmetrical T-shaped annular columns are arranged on the lower end face of the turning block, and the T-shaped annular columns can be inserted into the T-shaped annular grooves; and the structure of a central position of the lower end face of the turning block is annular teeth, and the annular teeth are meshed with the lead screw. The servomotor drives the lead screw to rotate, and by virtue of meshing matching of the annular teeth and the lead screw, the turning block can turn along the centers of the T-shaped annular grooves in the base.

During actual use, the servomotor starts working, and the lead screw rotates; by virtue of the meshing matching of the annular teeth and the lead screw, the lead screw drives the turning block to turn along the centers of the T-shaped annular grooves in the base; and by controlling the revolutions of the servomotor, the turning block can highly precisely turn for any angles.

In use, the high-precision turning device provided by the present invention can meet the requirement on high-precision turning and has the characteristics of simple structure, reliable work, high turning precision and the like.

### BRIEF DESCRIPTION OF DRAWINGS

FIG. 1 is a structural schematic diagram of a high-precision turning device provided by the present invention.

FIG. 2 is a structural schematic diagram of a turning mechanism of a high-precision turning device provided by the present invention.

FIG. 3 is an A-A schematic diagram of a turning mechanism of a high-precision turning device provided by the present invention.

FIG. 4 is a structural schematic diagram of a base of a high-precision turning device provided by the present invention.

FIG. 5 is an A-A schematic diagram of a base of a high-precision turning device provided by the present invention.

FIG. 6 is a structural schematic diagram of a turning block of a high-precision turning device provided by the present invention.

FIG. 7 is an A-A structural schematic diagram of a turning block of a high-precision turning device provided by the present invention.

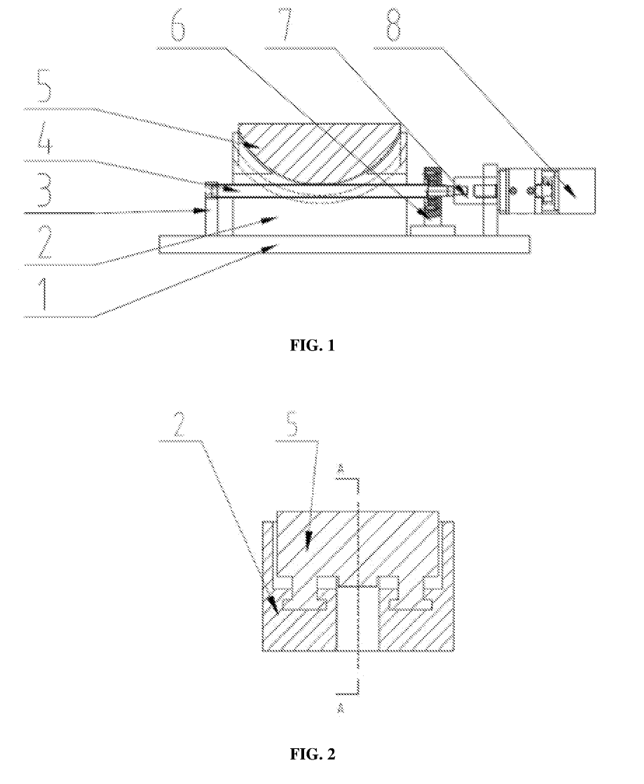

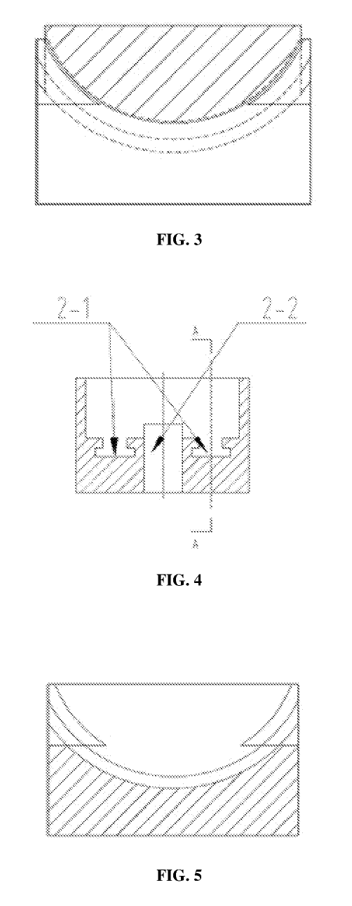

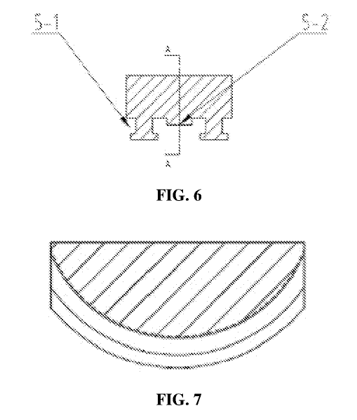

In the figure, numeric symbols are as follows: 1—base plate, 2—base, 2-1-T—shaped annular groove, 2-2—empty groove, 3—support A, 4—lead screw, 5—turning block, 5-1-T—shaped annular column, 5-2—annular tooth, 6—support B, 7—coupling, and 8—servomotor.

### DETAILED DESCRIPTION OF THE INVENTION

In the following, the details and working conditions of a specific device provided by the present invention are described in combination with figures.

A high-precision turning device is composed of a base plate 1, a base 2, a support A 3, a lead screw 4, a turning block 5, a support B 6, a coupling 7, and a servomotor 8. The support A 3, the support B 6 and the base 2 are fixed on the base plate 1, the lead screw 4 is mounted above the base plate 1 through the support A 3 and the support B 6, and the coupling 7 connects the lead screw 4 with the servomotor 8. An empty groove 2-2 is formed in the center of the bottom surface of the base 2, and the lead screw 4 passes through the empty groove 2-2; symmetrical T-shaped annular grooves 2-1 are formed in two sides of the interior of the base 2, two symmetrical T-shaped annular columns 5-1 are arranged on the lower end face of the turning block 5, and the T-shaped annular columns 5-1 can be inserted into the T-shaped annular grooves 2-1; and the structure of a central position of the lower end face of the turning block 5 is annular teeth 5-2, and the annular teeth 5-2 are meshed with the lead screw 4. The servomotor 8 drives the lead screw 4 to rotate, and by virtue of meshing matching of the annular teeth 5-2 and the lead screw 4, the turning block 5 can turn along the centers of the T-shaped annular grooves 2-1 in the base 2.

During actual use, the servomotor 8 starts working, and the lead screw 4 rotates; by virtue of the meshing matching of the annular teeth 5-2 and the lead screw 4, the lead screw 4 drives the turning block 5 to turn along the centers of the T-shaped annular grooves 2-1 in the base 2; and by controlling the revolutions of the servomotor 8, the turning block 5 can highly precisely turn for any angles.

1. A novel high-precision turning device, comprising:
a base plate, a base, a support A, a lead screw, a turning block, a support B, a coupling, and a servomotor;
wherein the support A, the support B and the base are fixed on the base plate, the lead screw is mounted above the base plate through the support A and the support B, and the coupling connects the lead screw with the servomotor;
an empty groove is formed in the center of the bottom surface of the base, and the lead screw passes through the empty groove;
symmetrical T-shaped annular grooves are formed in two sides of the interior of the base, two symmetrical T-shaped annular columns are arranged on the lower end face of the turning block, and the T-shaped annular columns can be inserted into the T-shaped annular grooves; and the structure of a central position of the lower end face of the turning block is annular teeth, and the annular teeth are meshed with the lead screw.

2. The high-precision turning device according to claim 1, wherein the servomotor drives the lead screw to rotate, and by virtue of meshing matching of the annular teeth and the lead screw, the turning block can turn along the centers of the T-shaped annular grooves in the base.
